(19) United States
(12) Patent Application Publication
(10) Pub. No.: US 2012/0079029 A1
(43) Pub. Date: Mar. 29, 2012

(54) Method And Arrangement For Obtaining A Media Object For A Device In A Local Network

(75) Inventors: Ayodele Damola, Solna (SE); Robert Skog, Hasselby (SE)

(73) Assignee: TELEFONAKTIEBOLAGET L M ERICSSON (PUBL), Stockholm (SE)

(21) Appl. No.: 13/375,615

(22) PCT Filed: Jun. 4, 2009
(86) PCT No.: PCT/SE09/50671

§ 371 Date: Dec. 1, 2011

(51) Int. Cl. G06F 15/16

(52) U.S. Cl. 709/204

(57) ABSTRACT

Method and arrangement in a home gateway (302) of a local network (300) for providing a media object according to a search request from a first local device (304). The media object is obtained from a peer-to-peer network by converting the search request into a peer-to-peer search request, and the media object is then fetcher by means of a peer-to-peer technique. A local media reference (URL) defined for the obtained media object is sent to the first device. When a media object request containing the local media reference is received from the first local device or from a second local device which has been selected as media renderer, the media object is delivered using the received local media reference. There by, users of devices in the local network can access content from outside the local network.

### TECHNICAL FIELD

The invention relates generally to a method and arrangement for obtaining and delivering a media object for a device in a local network.

### BACKGROUND

A multitude of different types of communication terminals or devices have been developed for packet-based multimedia communication using IP (Internet Protocol). Multimedia services typically involve transmission of media in different formats and combinations over IP networks. For example, an IP-enabled mobile terminal may exchange media such as visual and/or audio information with another IP-enabled terminal, or may download media from a content server over the Internet.

An architecture called “IP Multimedia Subsystem” (IMS) has been developed to enable such multimedia services and sessions for user terminals connected to different access networks. The signalling protocol “SIP” (Session Initiation Protocol) can be used for initiating media sessions between different parties, as controlled by specific session control nodes in the IMS network.

Sessions can also be established and handled solely by the media communicating parties without involving any intermediate IMS network or session controlling node, which are generally referred to as peer-to-peer (P2P) sessions. The participating parties themselves negotiate and agree on the session parameters to use, and media is then transmitted accordingly in data packets over various routers in an IP network, e.g. the Internet between the parties, or “peers”.

Peer-to-peer applications on the Internet are becoming very popular for downloading various multimedia content such as music and films. For example, a technique referred to as “Bit Torrent” is a very powerful distribution mechanism that is widely used for rapid sharing of multimedia content and software over the Internet without requiring a centralized content server. According to this mechanism, different parts of the total content are downloaded simultaneously from multiple communication nodes, or “peers”, and these content parts are then compiled at the receiving party to form the complete content or file(s). Furthermore, so-called Distributed Hash Tables, DHT:s, are typically used for identifying and selecting the peers for downloading.

In FIG. 1, a typical scenario is shown for a plurality of peer-to-peer sessions between a user terminal A and multiple opposite communication nodes B, C, D, . . . over routers R in an IP network 100, e.g. for downloading different content parts to terminal A, e.g. according to Bit Torrent. In this example, terminal A is connected to an access router or “edge node” E_{A}, e.g. a GGSN (Gateway GPRS Support Node) if a mobile access network is used, while the shown opposite communication nodes or peers B, C, D are connected to corresponding edge nodes E_{B}, E_{c} and E_{D}, respectively. The transmission path for each peer-to-peer session typically runs over multiple intermediate routers R in the network 100, which may vary for different data packets during the session, as is well-known in the art.

Techniques are also being developed for multimedia communication involving devices in a limited local network using internal addressing and transport means, also referred to as a residential or office network, LAN (Local Area Network), private or home network. In this description, the term “local network” represents any such networks, and the term “device” represents any entity capable of media communication inside a local network. The devices in a local network may include any types of entities capable of communication in the network, such as fixed and wireless telephones, computers, media players, servers and television boxes, the latter also called “STB” (Set Top Box). In order to provide multimedia communication with other parties outside the network, a gateway called “HIGA” (Home IMS Gateway), has been devised to provide an interface between devices in the local network and an IMS network for establishing sessions with external parties. The HIGA is specified in TISPAN (Telecommunications and Internet converged Services and Protocols for Advanced Networking).

UPnP (Universal Plug-and-Play) is an architecture, developed in the multi-vendor collaboration called UPnP Forum, for establishing standardised device protocols for communication in a local network between different devices that may use different access technologies, operating systems, programming languages, format standards and communication protocols. UPnP also supports the process called “discovery” in which a device can enter a local network, obtain a local IP address, announce its name and IP address, and exchange capabilities and services with other devices within the network.

DLNA (Digital Living Network Alliance) is a recently developed technology for acquiring, storing and accessing digital media content from devices in a local network. The UPnP protocol is utilised by DLNA as an underlying protocol for communication between DLNA devices within local networks. In this context, the local network is often called a DLNA network. It is required that DLNA devices support HTTP (Hyper Text Transport Protocol) as a basic transport mechanism for transfer of media across the local network. In addition, RTP (Real Time Protocol) can optionally be used as a media transport, but the mandatory requirements for HTTP must always be supported by the devices.

In FIG. 2, a local network 200 is shown with different devices, in this example including a wireless telephone, a fixed telephone, a TV apparatus, a laptop computer, and a media server. The network 200 also includes a gateway 202 called RGW (Residential Gateway), which is connected to an external access network 204 to provide for media transport outside network 200 for the devices. The local network 200 further includes a HIGA 206 providing a signalling connection to an IMS network 208. The HIGA 206 also has different internal interfaces towards the different devices in network 200, using device-specific protocols.

When HIGA 206 receives a request for a multimedia service from a local device 200a in network 200 using a device-specific interface/protocol, HIGA 206 translates the service request into a valid IMS request (typically a SIP invite message), to set up an IMS session on behalf of the local device using an IMS identity 212 associated with the device 200a. In a similar manner, HIGA 206 can also set up a media session with the device 200a when receiving a corresponding request from an external device 210 outside the network 200. In either case, the media is transported over the RGW 202 and the access network 204, as indicated by two-way arrows.

The flow of media in the network 200 may be characterised in terms of “pull” and “push”, meaning that content travels either to or from a user, respectively. The so-called Interoperability Guidelines for DLNA define communication schemes for different scenarios of system usage, including the following:
A) 2-Box Pull System Usage. The user operates a Digital Media Player (DMP) for finding and requesting content from a Digital Media Server (DMS). The media can then be played, or “rendered”, locally by the receiving DMP.
B) 2-Box Push System Usage. The user operates a device acting as “Push Controller” for distributing content from that device to a DMP or a Digital Media Renderer (DMR).
C) 3-Box System Usage. The user operates a first device acting as a Digital Media Controller (DMC) for finding and requesting content from a second device acting as a DMS. The user then selects a third device as a DMR and the content is then sent from DMS to DMR.

In the latter 3-box scheme, the first device is thus used for controlling the transfer of media from the second device to the third device within the local network. For example, a small handheld wireless phone with limited playout capacity may be used as a control unit to direct a laptop computer to stream visual media content to a TV set used as media renderer, in order to view the content on a larger screen and with greater quality as compared to the laptop computer. In the following description, the terms “2-box” and “3-box” are used for short to basically indicate the above schemes A) and C), respectively.

However, the schemes above and other available DLNA schemes are limited to rendering media available within the local network. Even though the HIGA can be used by local device users for accessing media available outside the network, the sessions are limited to the usage of an IMS system. Today, there are virtually unlimited amounts of media stored on various devices, servers and terminals which can generally be reached over the Internet using the P2P technique discussed above. Nevertheless, it is not possible for a device within a local DLNA network to conduct media sessions with external parties without compliance with an IMS system, thereby depriving the local device users of potentially interesting and attractive media.

### SUMMARY

It is an object of the invention to basically address the problems outlined above. Further, it is an object to provide a solution that enables a media communication between a device in a local network and one or more peers outside the network without requiring an intermediate session control system such as an IMS session control node. These objects and others may be obtained by providing a method and arrangement according to the independent claims attached below.

According to one aspect, a method is provided in a home gateway of a local network for providing media to a device in the local network. In the method, a device-specific search request for a media object is received from a first local device in the local network. The requested media object or an external reference to the media object is obtained from a peer-to-peer network outside the local network, by converting the device-specific search request into a peer-to-peer search request. A local media reference is defined for the obtained media object or external reference, and the local media reference is sent to the first local device in response to the search request.

When a media object request containing the local media reference is received from the first local device or from a second local device which has been selected as media renderer, the media object is delivered according to the media object request and using the received local media reference, wherein the home gateway has fetched the media object by means of a peer-to-peer technique. Thereby, users in the local network are not limited to rendering media available within the local network, but can also access media from outside the local network without requiring control functionality of an IMS network or similar.

According to another aspect, an arrangement is provided in a home gateway of a local network capable of providing media to a local device. The home gateway arrangement comprises a local network module configured to receive a device-specific search request for a media object from a first local device in the local network, an adaptor module configured to convert the device-specific search request into a peer-to-peer search request, and a peer-to-peer module configured to obtain the requested media object or an external reference to the media object from a peer-to-peer network outside the local network using the peer-to-peer search request. The peer-to-peer module is also configured to fetch the media object by means of a peer-to-peer technique.

The adaptor module is further configured to define a local media reference for the obtained media object or external reference. The local network module is further configured to send the local media reference to the first local device in response to the search request. The local network module is further configured to receive a media object request containing the local media reference from the first local device or from a second local device which has been selected as media renderer, and to deliver the media object according to the media object request and using the received local media reference.

Different embodiments are possible in the method and arrangement in the home gateway above.

In one embodiment, the obtained media object is stored as at least one file in a file storage. In another embodiment, the obtained media object is temporarily stored as sections in a buffer storage before streaming the media object to the local device that receives the delivered media object. The local media reference may be a URL (Universal Resource Locator) or URI (Universal Resource Identifier) pointing to the obtained media object. Further, the media object may be obtained as chunks from a plurality of peers of the peer-to-peer network.

The media object request may be received from the first device and the media object is then delivered to the first device. Alternatively, the media object request is received from the second device acting as media renderer, and the media object is then delivered to the second device.

The media object obtained from the peer-to-peer network may be converted into a format adapted to the local device that receives the delivered media object, if necessary. The local media reference may also be associated to an external reference to the media object and the requested media object can then be obtained from the peer-to-peer network after receiving the media object request.

The home gateway may communicate with local devices in the local network according to DLNA, while the home gateway may be a HIGA as specified in TISPAN if the local network is a DLNA network.

Further possible features and benefits of the invention will be explained in the detailed description below.

### BRIEF DESCRIPTION OF THE DRAWINGS

The invention will now be explained in more detail by means of exemplary embodiments and with reference to the accompanying drawings, in which:

FIG. 1 illustrates conventional peer-to-peer sessions between a user terminal A and a plurality of opposite peers over routers R in an IP network.

FIG. 2 illustrates schematically a local network with various different local devices and a home gateway for establishing an IMS session with an external terminal, according to the prior art.

FIG. 3 is a schematic network overview illustrating a procedure for obtaining media for a local device from a P2P network, in accordance with a possible embodiment.

FIG. 4 is a flow chart illustrating a procedure for providing a media object to a local device in a local network, in accordance with another embodiment.

FIG. 5 is a schematic block diagram illustrating an arrangement in a home gateway of a local network in more detail, in accordance with further embodiments.

FIG. 6 is a schematic network overview illustrating an alternative procedure when the home gateway of FIG. 5 obtains media from a P2P network for a local device acting as a DMR, in accordance with another possible embodiment.

FIG. 7 is a signalling diagram illustrating in more detail how the inventive solution can be implemented in practice, in accordance with further embodiments.

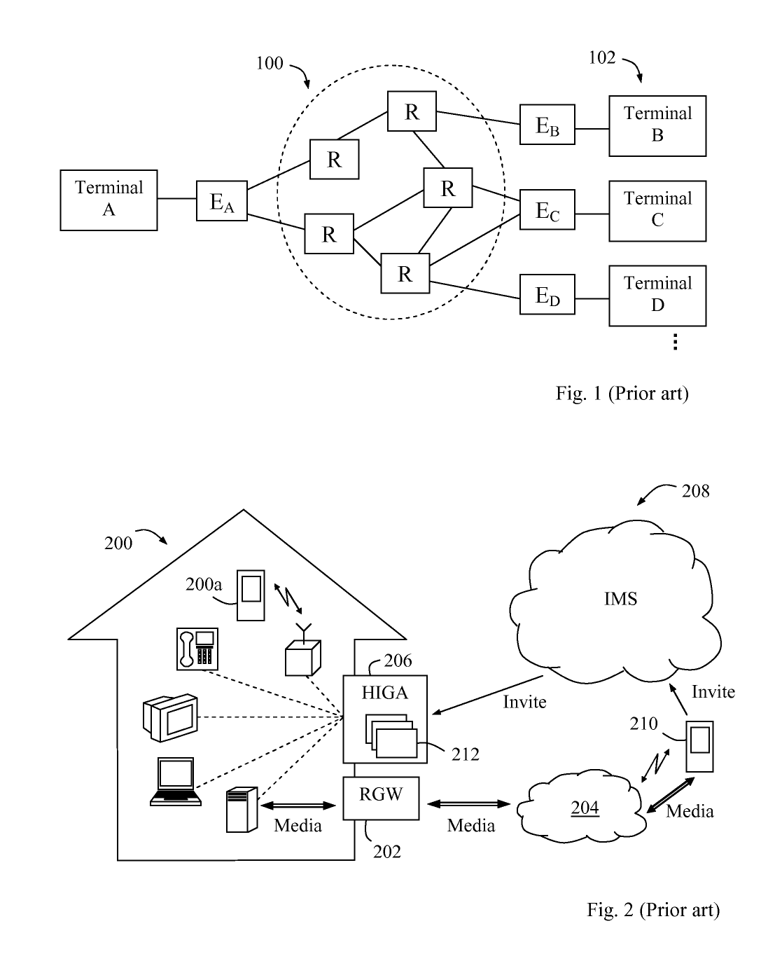

### DETAILED DESCRIPTION

Briefly described, the invention can be used for a device located within a local network to access media from external parties such as devices, servers and terminals outside the local network, by establishing a P2P session with each external party by means of a home gateway of the local network. The home gateway may be a HIGA as specified in TISPAN, although the invention is not limited thereto.

When a search request for a media object is received from a first local device, the home gateway converts the request into a regular P2P search request to a P2P network and obtains the requested media object from one or more peers in the P2P network using regular P2P procedures. When received at the home gateway, the media object may be stored as a file in a file storage, or temporarily stored as sections in a buffer storage for immediate streaming therefrom to the local device.

The home gateway also defines a local media reference, such as a URL, URI or similar network identifier, for the obtained media object and sends the media reference to the first local device in response to the previously received search request. The first local device can then display a suitable acknowledging message to the user and, in response to a user input command such as pressing a play button, request the media object from the home gateway referring to the received local media reference. The home gateway will then transfer the media object from the file or buffer storage to the first local device.

Alternatively, the first device may instruct a second local device to play out the media object, the second device thus acting as a DMR if the above-described 3-box scheme is used and the first local device acts as a DMC for the DMR. In that case, the first device transfers the received local media reference to the second local device which then requests the media object from the home gateway referring to the local media reference. The home gateway then accordingly delivers the media object to the second local device for playout on that device.

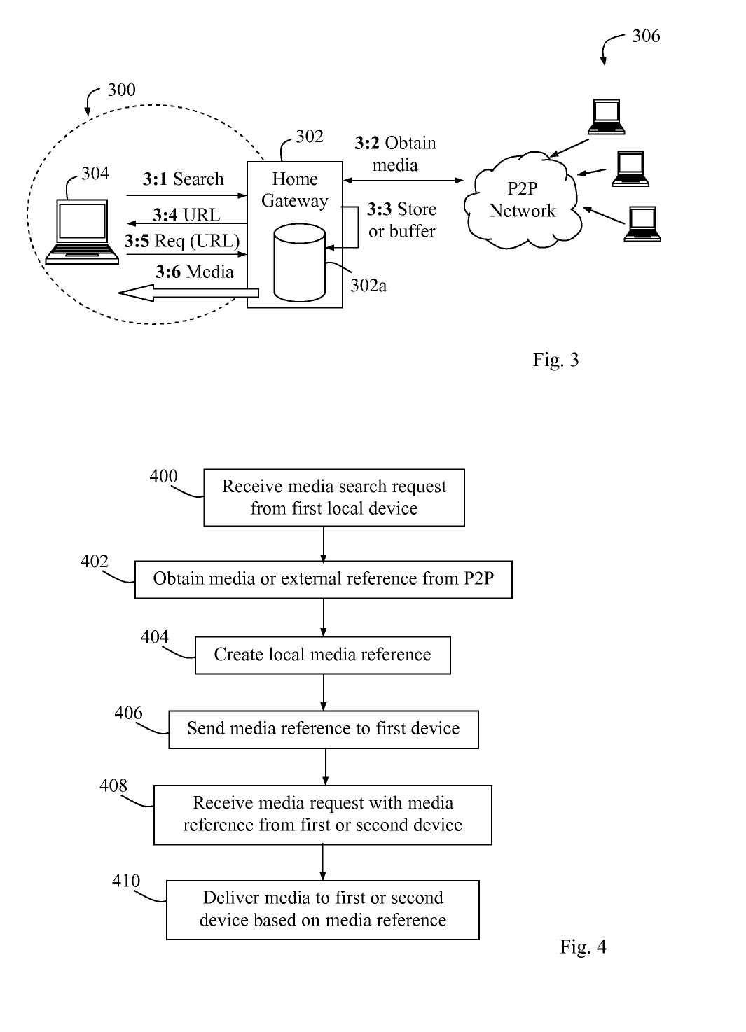

An exemplary procedure for obtaining media for a local device from a P2P network, will now be described with reference to FIG. 3 where a local network 300 comprises a home gateway 302 and at least one local device 304. The home gateway 302 is capable of communication with external peers 306 over a P2P network as schematically illustrated. The home gateway 302 may be configured with a DMS and a so-called Content Directory Service CDS which can receive media search requests and provide information on where in the local network the requested media can be found, according to previously known mechanisms. In this example, the above described 2-box model is basically employed where device 304 will act as a DMP that requests content from the DMS/CDS in the gateway 302, to be played out, or rendered, by the device 304.

In a first step 3:1, device 304 sends a search request for a media object to the home gateway 302 which may be a regular request directed to the above-mentioned CDS if used. The search request is “device-specific”, implying that the device 304 uses a communication protocol or messaging language that is specific for devices within the local network 300 and which cannot be used outside network 300. In the case of a DLNA network, the search request may be a standard DLNA content search request to the CDS in the home gateway 302. The CDS in gateway 302 may then first check whether the requested media is available within the local network 300 according to regular procedures, which is however outside the scope of this solution which is used when the requested media is not available in the local network 300. In this solution, the home gateway 302 will fetch the media object from the P2P network by means of a regular P2P technique as follows.

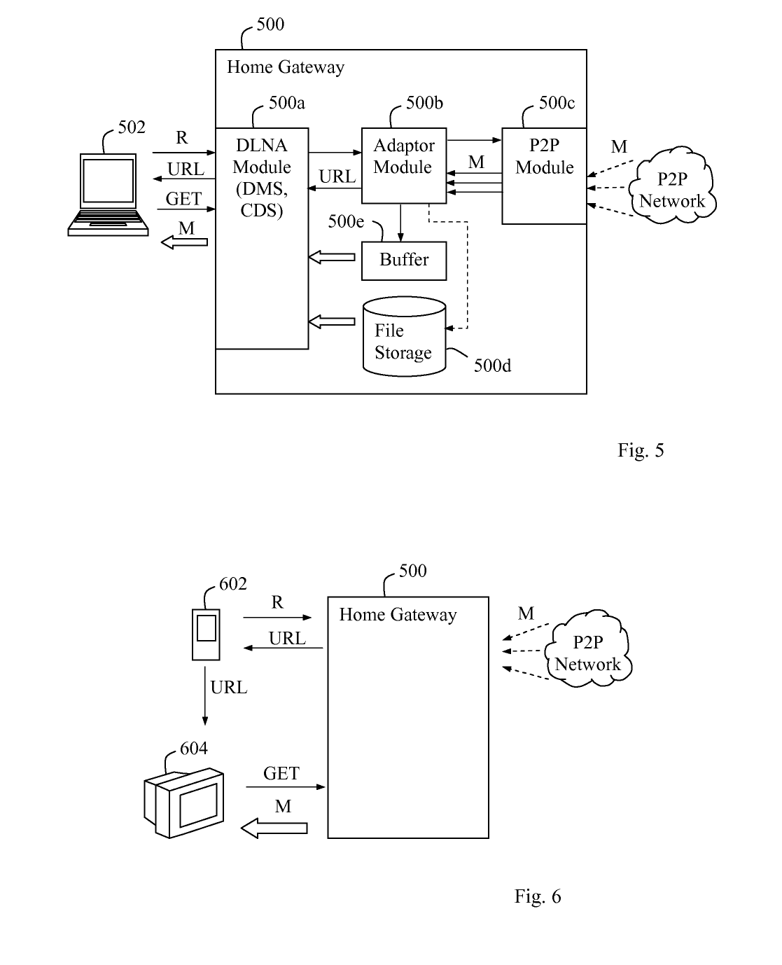

A next step 3:2 illustrates that the home gateway 302 basically obtains the requested media from one or more peers 306 over the P2P network. This can be done by converting the device-specific search request into a regular P2P search request which is used to fetch the media object by means of the P2P technique in a conventional manner, which will be described below in more detail in another example shown in FIG. 5. For the time being, it can be briefly mentioned that gateway 302 sends the P2P search request to a portal, e.g. a “torrent repository”, holding a database of content titles with links to so-called torrent files, and a tracker node then provides a list of peers from which the media object is available. The gateway will then download the media object from one or more peers according to the received list, i.e. using the conventional P2P technique.

In a next step 3:3, the obtained and downloaded media object is stored or buffered in a suitable storage unit 302a at the receiving gateway 302. The media object may be stored as a file or temporarily buffered as sections with data packets, and the storage unit 302a may thus be capable of storing media files for delivery by means of file transfer, and/or capable of buffering data packets for delivery by means of data streaming, depending on the implementation.

The media object may be received in a format not supported by the local device to which the media object is to be delivered. In this step, the received media object may therefore be first converted into a format supported by the local device, before storing or buffering it in the storage unit 302a. Alternatively, the media object may be stored in the received format and then be converted into an appropriate device-adapted format before delivery. In some cases, it may not be necessary at all to convert the received media object to another format, depending on the capability of the receiving local device. That is, the device that will receive and play out the media object may be capable of handling the media format as received from the P2P network.

The home gateway 302 then defines a local media reference for the obtained and stored media object, effectively pointing to the media object in the storage unit 302a. The local media reference may be a HTTP based URL or any other suitable reference or identifier that is associated to the media object in storage 300a. The invention is thus not limited to any particular type of reference format or standard. A following step 3:4 illustrates that the local media reference is sent to the local device 304 in response to the search request of step 3:1.

Another possibility is that the local device 304 forwards the media reference to another local device in the network 300 acting as DMR, if the 3-box model is used where device 304 is a control point DMC and the other device is a media renderer DMR, which will be described further below with reference to FIG. 6. The response message in this step may be a standard DLNA search response containing the local media reference, e.g. URL. If the gateway 302 has failed to obtain the requested media object in step 3:2 above, such as when it is not available from the P2P network nor from the local network 300, the message in step 3:4 will be a conventional negative search response.

In this example, the user of device 304 will see a positive result of the search request displayed on the device after step 3:4, and is now able to enjoy the media object by pressing a play button or the like which will trigger another device-specific request message from device 304 to gateway 302 in a further step 3:5. This request may be a HTTP GET message or other suitable media request message, referring to the above-received local media reference, e.g. URL, for fetching the media object from the gateway 302. In response thereto, the home gateway 302 delivers the media object from storage unit 302a to the requesting local device 304 in a final shown step 3:6, either by means of file transfer or data streaming depending on the storage method in step 3:3 as described above.

In this way, the local device can basically use conventional procedures in steps 3:1, 3:4, 3:5 and 3:6 for obtaining the media object, even if the object is not available within the local network 300 and must be obtained from the P2P network. Thus, the local device 304 and its user will effectively perceive the procedure as if the media object was available and delivered from the local network according to conventional technique, e.g. as of DLNA. However, the P2P search and download in step 3:2 may cause an additional delay that may be noticed, as compared to the case of local availability and delivery.

A procedure for providing a media object to a local device in a local network, as executed by a home gateway, will now be described with reference to the flow chart in FIG. 4. This procedure may be conducted by the home gateway 302 basically in the manner described for FIG. 3. In a first step 400, the home gateway receives a device-specific search request from a first local device in the local network referring to a wanted media object, as in step 3:1 above. The first device may be a DMP according to the 2-box model or a DMC according to the 3-box model the latter involving a second device in the local network which has been selected as a DMR.

The gateway then obtains the requested media object, or an external reference to the requested media object, from a P2P network outside the local network, in a next step 402, e.g. after first checking whether the wanted media object is available within the local network which is however outside the scope of this solution. In this step, basically corresponding to step 3:2 above, the media object or external reference is obtained from the P2P network by converting the received device-specific search request into a regular P2P search request. The media object can be fetched, typically by downloading, by means of the conventional P2P technique.

The obtained, or downloaded, media object is also stored in a suitable media storage at the home gateway, optionally after converting the format of the media object according to the capability of the receiving local device, e.g. as described for step 3:3 above. In a further step 404, a local media reference is defined for the obtained media object or external reference, such as a URL, URI or other reference associated to the media object. The defined local media reference is then sent to the first device in a following step 406, basically corresponding to step 3:4 above, in response to the search request of step 400.

If the user of the receiving first device decides to actually view and/or hear the searched media object, he/she will press a play button or the like on the device which then sends a media request containing the received local media reference, which is received by the home gateway in a further step 408, basically corresponding to step 3:5 above. The user may alternatively decide to view and/or hear the media object on a second device. In the latter case, the first device transfers the local media reference to the second device, and the media request containing the local media reference will be received from the second device in step 408.

The media request from either the first or the second device may be a regular HTTP GET message or any other equivalent message according to standards and protocols used in the local network. In response thereto, the home gateway retrieves the media object from its media storage and delivers it to the requesting first or second local device, in a final shown step 410. The media object may be delivered to the device either as a file transfer or as streamed data, depending on the implementation. Further, the media object may be converted into a format adapted to the capability of the device if necessary, and/or if not already done before storing the media object at the home gateway, as described above.

The procedure in FIG. 4 can be somewhat modified depending on the implementation, by obtaining the media object at a later stage, i.e. not until after receiving the media request in step 408. In that case, the home gateway makes a P2P search for the wanted media object after step 402 and obtains an external reference to the media object, e.g. an URI or a torrent file, from the P2P network. The local media reference defined in step 404 is thus associated to the external reference. After receiving the media request in step 408, the home gateway uses the external reference to obtain the media object from the P2P network for delivery in step 410.

Referring to the schematic block diagram in FIG. 5, an arrangement in a home gateway 500 of a local network will now be described in more detail, particularly when the 2-box model is employed according to a first example. The home gateway is generally adapted to provide media to local devices in the local network such as the shown device 502. The home gateway 500 comprises a local network module 500a, here denoted “DLNA module” although without limiting the invention to DLNA, which is configured to receive a device-specific search request “R” for a media object from local device 502. Home gateway 500 further comprises an adaptor module 500b configured to convert the device-specific search request into a P2P search request. The home gateway 500 also comprises a P2P module 500c configured to obtain the requested media object from a P2P network outside the local network according to the P2P search request and by fetching the media object by means of a P2P technique.

The home gateway 500 may further comprise a file storage 500d configured to store the obtained media object as at least one file, and/or a buffer storage 500e configured to store the obtained media object temporarily as sections before streaming the media object to the local device that receives the delivered media object, in this case device 502.

When the media object “M” is received by the P2P module 500c, the adaptor module 500b is further configured to define a local media reference “URL” for the obtained media object. Even though the URL is used here as the media reference, the invention is not limited to the URL format for media references, as mentioned above. The local network module 500a is then configured to send the media reference URL to the device 502 in response to the search request R.

Thereby, the user of device 502 is able to fetch the media object from home gateway 500 by a suitable input command which triggers a media object request referring to the media reference URL. The media object request may be a HTTP GET message or any other equivalent message depending on the protocol used. Alternatively, the user may trigger a media object request from another device, which will described below with reference to a second example employing the 3-box model.

The local network module 500a is further configured to receive a media object request “GET” containing the local media reference URL, from the local device 502 in the case of FIG. 5, and to deliver the media object M according to the media object request and using the received local media reference. Thus in this example, the media object request was received from the same device 502 having made the media search request R, and the media object M is delivered to that device 502 according to the 2-box model. The adaptor module may be further configured to convert the obtained media object into a format adapted to the local device that receives the delivered media object, if necessary. As mentioned above, the receiving device may be capable of handling the media object in the format received by the gateway 500 wherein no format conversion is necessary.

Referring to the schematic block diagram in FIG. 6, it will now be described how the home gateway 500 of FIG. 5 would act according to a second example when the 3-box model is employed. Here, a user makes the initial device-specific media search request “R” from a first local device 602 with the intention of playing out the media object on a second local device 604. For example, the first device 602 may be a control point suitable for searching for media objects but may have limited capacity for receiving and playing out the wanted media object, while the second device 604 may be a media renderer more suitable in the latter respect. For simplicity, the home gateway 500 is shown in FIG. 6 without its functional modules and storages which however are used basically as explained for FIG. 5 above.

When the home gateway 500 has converted the device-specific search request into a P2P search request and obtained the media object in the manner described above for FIG. 5, the media reference “URL” is sent to first device 602. When the user of device 602 makes a suitable input command to select the second device 604 for playing out the media object, the first device 602 transfers the media object to the second device 604 with an instruction to fetch the media object from gateway 500, as shown in the figure. Accordingly, the home gateway 500 receives a media object request “GET” containing the local media reference URL, from the local device 604 and delivers the media object M to device 604 according to the media object request, using the received local media reference.

In FIG. 5, the P2P module 500c may be further configured to obtain the media object M as chunks from a plurality of peers of the P2P network. The local network module 500a may further be configured to receive the media object request GET either from the first device 502 for delivery thereto, or from the second device 604 for delivery to the second device. The adaptor module 500b may also be configured to associate the local media reference to an external reference to the media object, and the P2P module 500c may be configured to obtain the requested media object from the P2P network after the local network module has received the media object request.

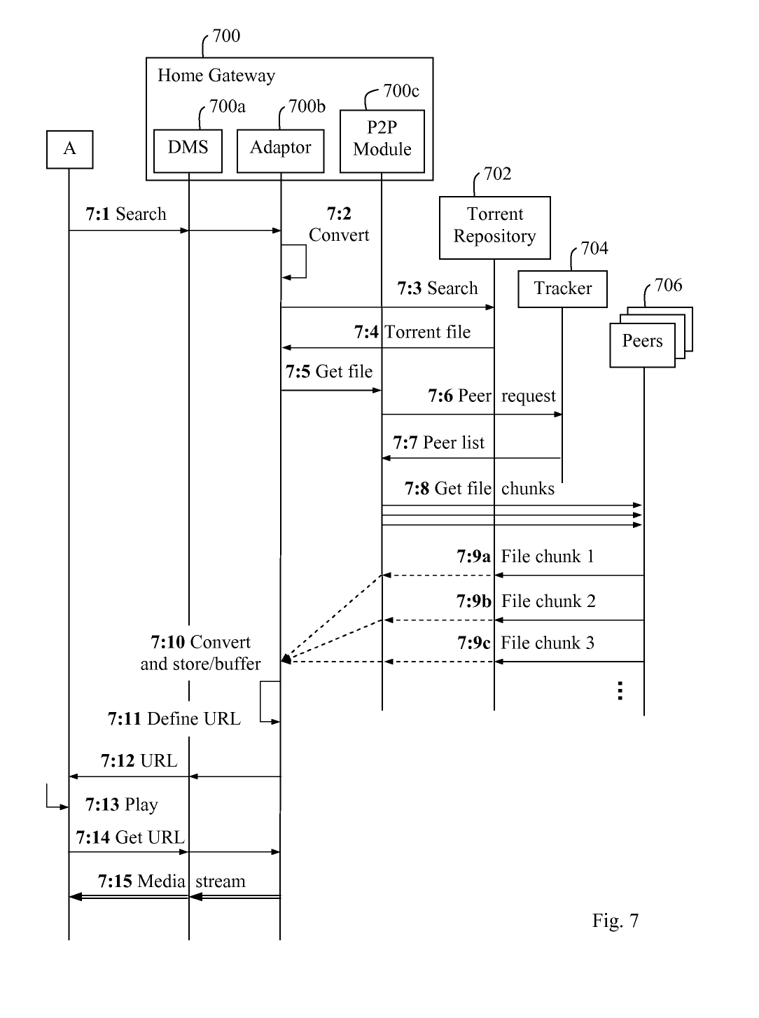

A detailed example of how a media object can be provided to a local device by means of a home gateway, will now be described with reference to the signalling diagram in FIG. 7. In this figure, the 2-box model is used where a local device A in a local DLNA network will act as a DMP that requests content from a DMS/CDS in a home gateway 700, to be played out, or rendered, by the device A, as similar to the situation in FIG. 3. The home gateway 700 is capable of obtaining media objects from a P2P network comprising a torrent repository 702 holding a database of content titles with links to corresponding torrent files, a tracker node 704 capable of providing peers where media is stored, and a plurality of peers 706. In more detail, the home gateway 700 comprises a CDS module 700a for handling content requests from devices within the DLNA network, an adaptor module 700b for translating messages and data between the local network and the P2P network, and a P2P module 700c for communication with the P2P network.

In a first step 7:1, device A sends a device-specific standard DLNA content search request for a wanted media object to the CDS module 700a in gateway 700, and an internal message conveys the search request from the CDS module 700a to the adaptor module 700b. The adaptor module 700b then converts the DLNA content search request into a P2P search request, in a next step 7:2.

The P2P search request is sent to the torrent repository 702 in a following step 7:3, which then responds by providing a torrent file corresponding to the searched media object, in a next step 7:4. If no entry matching the search request is found in the torrent repository 702, an empty search result would be returned in step 7:4 which then would be converted into a relevant DLNA message which could be a “case error code 710” referred to as “No such container”.

In this example however, adaptor module 700b sends an internal command “get file” to the P2P module 500c, in a next step 7:5, to initiate the P2P application to start downloading the media object from the P2P network based on the torrent file received in step 7:4. The P2P module 500c then sends a request to the tracker node 704 for a list of peers from which a file with the media object, or at least parts of that file, can be downloaded, in a step 7:6. The list of peers is then provided as a response by the tracker node 704, in a next step 7:7.

A next schematic step 7:8 illustrates that the P2P module 500c establishes P2P sessions with a plurality of peers 506 according to the received peer list, requesting for chunks of the media file from the multiple peers 506. The following steps 7:9a,b,c . . . illustrate further that different file chunks 1,2,3, . . . are downloaded accordingly from the peers 506 during the individual P2P sessions. In this example, the received file chunks are then converted by the adaptor module 700b into a media format adapted to the requesting device A, and the converted media object is stored in a media storage, as illustrated by a further step 7:10. The media file may be stored as a newly created file or buffered as data packets, depending on the implementation.

In a next step 7:11, a URL is defined by the adaptor module 700b as a local media reference pointing to the stored media object. The URL is then passed in an internal message from adaptor module 700b to CDS module 700a, and a standard DLNA search response containing the URL is sent from CDS module 700a to the local device A in response to the request of step 7:1, in a further step 7:12. The user of device A will now be able to see the positive result of the media search and inputs a play command in a step 7:13, which triggers the device A to send a HTTP GET message referring to the URL as a media request to the CDS module 700a, in a following step 7:14. The media request is also passed to the adaptor module 700b which then accordingly retrieves the media object from its media storage and conveys it to the CDS module 700a for eventual delivery to the device A, as shown in a final step 7:15.

As in the case of FIG. 4, the procedure in FIG. 7 can be modified by fetching the media object according to steps 7:5-7:10 after the media request has been received in step 7:14. In that case, the home gateway obtains the torrent file in step 7:4 as an external reference and basically associates the local media reference to the torrent file in step 7:11. When the media request is received in step 7:14, the home gateway 700 uses the torrent file to obtain the media object from the P2P network for delivery in step 7:15.

The above-described solution and embodiments will enable the use of any local devices in a local network for accessing and obtaining content from P2P networks without requiring any added functionality in the device used. As a result, the user will not be limited to content only available within the local network. Furthermore, content providers will gain a potential business opportunity to use P2P technology for delivering content to local device users, while at the same time making home devices, e.g. based on DLNA, more attractive by the extended field of usage.

While the invention has been described with reference to specific exemplary embodiments, the description is only intended to illustrate the inventive concept and should not be taken as limiting the invention. Although the concepts of HIGA, UPnP and DLNA have been used when describing the above embodiments, any other similar suitable standards, protocols and network elements may basically be used for enabling the communication from a local network as described herein. The invention is generally defined by the following independent claims.

1.-20. (canceled)

21. A method in a home gateway of a local network for providing media to a device in the local network, the method comprising:
receiving a device-specific search request for a media object from a first local device in the local network;
obtaining the requested media object from a peer-to-peer network outside the local network by converting the device-specific search request into a peer-to-peer search request;
storing or buffering the obtained media object in a media storage of the home gateway;
defining a local media reference for the obtained media object, the local media reference pointing to the media object in the media storage;
sending the local media reference to the first local device in response to the search request;
receiving a media object request containing the local media reference from the first local device or from a second local device which has been selected as a media renderer; and
delivering the media object from said media storage according to the media object request and using the received local media reference, wherein the home gateway has fetched the media object by means of a peer-to-peer technique.

22. The method according to claim 21, wherein storing or buffering the obtained media object comprises storing the obtained media object as at least one file in a file storage.

23. The method according to claim 21, wherein storing or buffering the obtained media object comprises temporarily storing the obtained media object as sections in a buffer storage before streaming the media object to the local device that receives the delivered media object.

24. The method according to claim 21, wherein the local media reference comprises a Universal Resource Locator (URL) or Universal Resource Identifier (URI) pointing to the obtained media object.

25. The method according to claim 21, wherein obtaining the requested media object comprises obtaining the requested media object as chunks from a plurality of peers of the peer-to-peer network.

26. The method according to claim 21, wherein receiving the media object request comprises receiving the media object request from the first local device, and wherein delivering the media object comprises delivering the media object to said first local device.

27. The method according to claim 21, wherein receiving the media object request comprises receiving the media object request from the second local device, and wherein delivering the media object comprises delivering the media object to said second local device.

28. The method according to claim 21, further comprising converting the media object obtained from the peer-to-peer network into a format adapted to the local device that receives the delivered media object.

29. The method according to claim 21, wherein the home gateway communicates with local devices in the local network according to Digital Living Network Alliance (DLNA).

30. The method according to claim 21, wherein the home gateway comprises a Home Internet protocol Multimedia Subsystem (IMS) Gateway (HIGA) as specified in Telecommunications and Internet converged Services and Protocols for Advanced Networking (TISPAN), and the local network comprises a Digital Living Network Alliance (DLNA) network.

31. An arrangement in a home gateway of a local network configured to provide media to a device in the local network, the arrangement comprising:
a local network module configured to receive a device-specific search request for a media object from a first local device in the local network;
an adaptor module configured to convert the device-specific search request into a peer-to-peer search request; and
a peer-to-peer module configured to obtain the requested media object from a peer-to-peer network outside the local network using the peer-to-peer search request and to fetch the media object by means of a peer-to-peer technique;
wherein the adaptor module is further configured to store or buffer the obtained media object in a media storage of the home gateway and define a local media reference for the obtained media object or an external reference, the local media reference pointing to the media object in the media storage;
wherein the local network module is further configured to send the local media reference to the first local device in response to the search request; and
wherein the local network module is further configured to receive a media object request containing the local media reference from the first local device or from a second local device which has been selected as media renderer, and to deliver the media object from said media storage according to the media object request and using the received local media reference.

32. The arrangement according to claim 31, wherein the adaptor module is further configured to convert the obtained media object into a format adapted to the local device that receives the delivered media object.

33. The arrangement according to claim 31, further comprising a file storage configured to store the obtained media object as at least one file.

34. The arrangement according to claim 31, further comprising a buffer storage configured to store the obtained media object temporarily as sections before streaming the media object to the local device that receives the delivered media object.

35. The arrangement according to claim 31, wherein the local media reference comprises a Universal Resource Locator (URL) or Universal Resource Identifier (URI) pointing to the obtained media object.

36. The arrangement according to claim 31, wherein the peer-to-peer module is further configured to obtain the media object as chunks from a plurality of peers of the peer-to-peer network.

37. The arrangement according to claim 31, wherein the local network module is further configured to receive the media object request from the first local device and to deliver the media object to said first local device.

38. The arrangement according to claim 31, wherein the local network module is further configured to receive the media object request from the second local device acting as a media renderer, and to deliver the media object to said second local device.

39. The arrangement according to claim 31, wherein the local network module is further configured to communicate with local devices in the local network according to Digital Living Network Alliance (DLNA).

40. The arrangement according to claim 31, wherein the home gateway comprises a Home Internet protocol Multimedia Subsystem (IMS) Gateway (HIGA) as specified in Telecommunications and Internet converged Services and Protocols for Advanced Networking (TISPAN), and the local network comprises a Digital Living Network Alliance (DLNA) network.
